(19) United States
(12) Patent Application Publication
(10) Pub. No.: US 2020/0124202 A1
(43) Pub. Date: Apr. 23, 2020

(54) PNEUMATIC ACTUATOR

(71) Applicant: FESTO AG & Co. KG, Esslingen (DE)

(72) Inventors: Harald Röhrig, Spiesen-Elversberg (DE); Andreas Weisang, Gersheim (DE)

(21) Appl. No.: 16/657,427

(22) Filed: Oct. 18, 2019

(30) Foreign Application Priority Data
Oct. 22, 2018 (DE) 102018217986.7

(51) Int. Cl. F16K 31/122; F15B 15/02

(52) U.S. Cl. CPC F16K 31/1221; F15B 15/02

(57) ABSTRACT

A pneumatic actuator for controlling a valve, having a working piston which is movably accommodated in a cylinder housing along a movement axis and delimits a working space of variable size with the cylinder housing and which is connected to a piston rod which extends along the movement axis, the cylinder housing including a first outer body with a sleeve-shaped first piston rod guide and a second outer body with a sleeve-shaped second piston rod guide, wherein the two piston rod guides are arranged spaced apart from one another along the axis of movement, the working space being bounded by the first outer body and by the second outer body, and the piston rod passing through the end of the cylinder housing, wherein the piston rod is provided with a sealing in order to form a sealing connection with the associated piston rod guide.

### BACKGROUND OF THE INVENTION

The invention concerns a pneumatic actuator for controlling a valve, in particular a process valve, with a working piston which is movably accommodated in a cylinder housing along an axis of movement and delimits a working space of variable size with the cylinder housing and which is connected to a piston rod extending along the axis of movement, wherein the cylinder housing has a one-piece cup-shaped first outer body with a sleeve-shaped first piston rod guide arranged centrally in the first outer body and a one-piece cup-shaped second outer body with a sleeve-shaped second piston rod guide arranged centrally in the second outer body, wherein the first piston rod guide and the second piston rod guide are spaced apart along the axis of movement and arranged coaxially to one another and are designed for a linearly movable guidance of the piston rod, wherein the working space is bounded by the first outer body and by the second outer body and wherein the piston rod passes through the end of the cylinder housing.

A pneumatic valve drive is known from EP 1 505 325 B1 which comprises a housing having a cylindrical guide sleeve and a plastic end wall at each axial end of the liner, wherein a piston connected to an axial spindle is axially guided in the guide sleeve and is sealed at its circumference against the inner wall of the guide sleeve, and wherein cylindrical outer wall parts are integrally formed on the end walls, which cylindrical wall parts are screwed together and are surrounded by a cylindrical shell made of a thin-walled stainless steel and axially braced between the end walls.

### SUMMARY OF THE INVENTION

The purpose of the invention is to provide a pneumatic actuator that allows a simplified design.

This task is solved for a pneumatic actuator according to the invention. Here it is intended that the piston rod is provided with a sealing in order to form a sealed connection with the associated piston rod guide. By assigning the sealing, which ensures a sealing between the piston rod and the piston rod guide, to the piston rod, the first outer body and the second outer body comprising the respectively assigned piston rod guide can be produced cost-effectively. In addition, the assembly of the sealing on the piston rod can be simplified considerably. It is preferable for the piston rod guide to have a smooth inner surface facing the piston rod, on which the sealing can slide in a sealing manner along the path of movement when the piston rod moves linearly.

The preferably circular-cylindrical piston rod can, for example, be equipped with a sealing applied in positive substance jointing, in particular by vulcanizing, to the outer surface of the piston rod. In this case it is not necessary to insert a sealing groove into the piston rod to receive the sealing.

Alternatively, it is possible to mount the sealing, which may be designed as a sealing ring, between two pipe sections pushed onto the piston rod, whereby the pipe sections are connected to the piston rod in a force-locked (friction locked) manner or material-locked (positive substance jointing) manner.

A preferred design for attaching the sealing to the piston rod is achieved with the piston rod having a circumferential sealing groove, which is cut during machining of the piston rod, for example, and for the sealing to be accommodated in the circumferential sealing groove. The sealing is preferably in the form of a shaft sealing ring which is pushed onto the piston rod for assembly in the sealing groove and is elastically deformed during the mounting process and which experiences a reduction in its elastic deformation when the sealing groove is reached and which is positively received in the sealing groove. Preferably, the sealing groove is circular in shape with a rectangular cross-section, in particular with a square cross-section.

In a further embodiment of the invention, it is intended that the first outer body with the first piston rod guide is designed as a plastic injection-moulded part and/or in that the second outer body with the second piston rod guide is designed as a plastic injection-moulded part. This enables cost-effective production of the first outer body and/or the second outer body with the associated piston rod guide. This enables series production of the respective outer bodies with the associated piston rod guides. The arrangement of at least one sealing element on the piston rod means that the inner surface of the piston rod guide can be formed with a constant cross-section along the axis of movement, so that in this area no undercut or technically complex structures need to be provided. In addition, the advantages of the plastic injection moulding process can be used, with which both the correct alignment between outer body and piston rod guide as well as the smooth inner surface of the piston rod guide required for the sealing of the piston rod can be achieved in a single operation.

According to another embodiment of the invention it is provided that a fluid connection for the connection of a fluid line is formed on an outer surface of the first outer body and that a fluid channel starting from the fluid connection penetrates the first outer body. The fluid connection enables the supply or discharge of a fluid, in particular compressed air, into the working chamber or out of the working chamber. For this purpose, the fluid connection and the first outer body are penetrated by a fluid channel which is designed for a fluidically communicating connection between a fluid line connectable to the fluid connection and the working chamber. As an example, it can be provided that the fluid connection comprises a metal part inserted in the outer body in a material-locking manner, in particular on a threaded insert, with the aid of which a screw connection of a fluid line to the fluid connection is made possible. Such a design of the fluid connection is of particular interest if the outer body is designed as a plastic injection-moulded part. In this case, the threaded insert can, for example, be designed as an insert part for the plastic injection moulding process or alternatively to be pressed in during an assembly process following the plastic injection moulding process.

It is preferable that the fluid connection placed on the outer surface of the first outer body is surrounded by a frame-shaped projection, on which a plate-shaped cover is fixed, in particular a material-locking manner, which cover is penetrated by the fluid connection. The frame-shaped projection and the plate-shaped cover ensure an optically appealing design of the first outer body in the area of the at least one fluid connection. For example, the plate-shaped cover can be used to cover a portion of the outer surface of the first outer body which is otherwise optically less appealing due to the columnar shape of the at least one fluid connection and the structures thus required for carrying out the plastic injection moulding process in this area. In addition or as an alternative, a cavity formed between the outer surface of the first outer body and the plate-shaped cover can be used, for example, to accommodate passive components such as an RFID tag, which can be read out and/or written to wirelessly and enables convenient identification of the pneumatic actuator.

It is preferred that an adapter sleeve, which extends coaxially to the second piston rod guide and which is penetrated by the piston rod is formed on the second outer body, which adapter sleeve is provided at the end with a guide sleeve made of a metallic material and that the piston rod is provided with a locking device arranged at the end for coupling to an actuating rod of a valve, in particular of a process valve. The adapter sleeve is used for a mechanical coupling of the pneumatic actuator with a housing of the valve or process valve. It is also possible that a union nut is rotatably mounted on the adapter sleeve, which enables the pneumatic actuator to be fixed to a housing of the valve or a housing of the process valve.

It is also possible to provide that the end of the piston rod is equipped with a locking device that enables it to be coupled, preferably without tools, to an actuating rod of the valve or process valve to be controlled. As an example, the piston rod comprises one or more bores at the end aligned transversely to the axis of movement, in which locking elements, in particular locking balls, can be arranged, with which the piston rod can be positively locked to a corresponding end section of the actuating rod of the valve or process valve. Such a locking between the piston rod and the actuating rod is supported by the fact that a guide sleeve made of metallic material is arranged in the adapter sleeve, in particular is inserted in a material-locking manner, which is designed to absorb coupling forces between the locking device and the actuating rod of the valve or process valve.

It is useful if a receiving sleeve is formed on the first outer body which extends coaxially with the first piston rod guide, which receiving sleeve delimits a common recess with the first piston rod guide and which is designed for movably receiving a functional element arranged at the end of the piston rod from the group: optical display, sensor, travel limiter. The receiving sleeve thus makes it possible to extend the function of the pneumatic actuator. By means of the receiving sleeve, a movement of the piston rod, which is guided in the receiving sleeve and in the piston rod guide, can be used to signal and/or determine a working position of the piston rod and/or to limit a linear movement of the piston rod along the movement path. For example, a cap mounted at the end of the piston rod and arranged in a common recess can be used as an optical signal means, enabling a user to qualitatively determine a relative position of the piston rod. Alternatively, a magnetic element designed to provide a magnetic field can be arranged at one end of the piston rod. The magnetic field can be detected by a measuring sensor, in particular a Hall sensor, which may be fixed to the first outer body in order to determine a relative position between the piston rod and the first outer body. In a further alternative embodiment it may be provided that an adjustment means, which is fixed on the first outer body projects into the recess and is designed to limit the displacement of a linear movement of the piston rod.

It is advantageous if the first outer body is sealingly connected to the second outer body, preferably screwed, in particular screwed and locked by positive substance jointing, in particular gluing.

### BRIEF DESCRIPTION OF THE DRAWINGS

An advantageous design of the invention is shown in the drawing. Here shows:

FIG. 1 a perspective exterior view of a pneumatic actuator, and

FIG. 2 a sectional view of the pneumatic actuator it according to FIG. 1.

### DETAILED DESCRIPTION

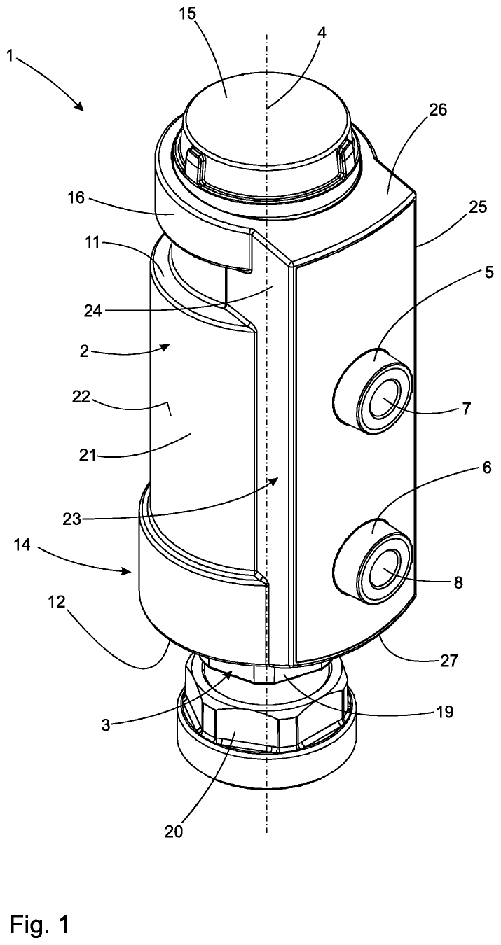

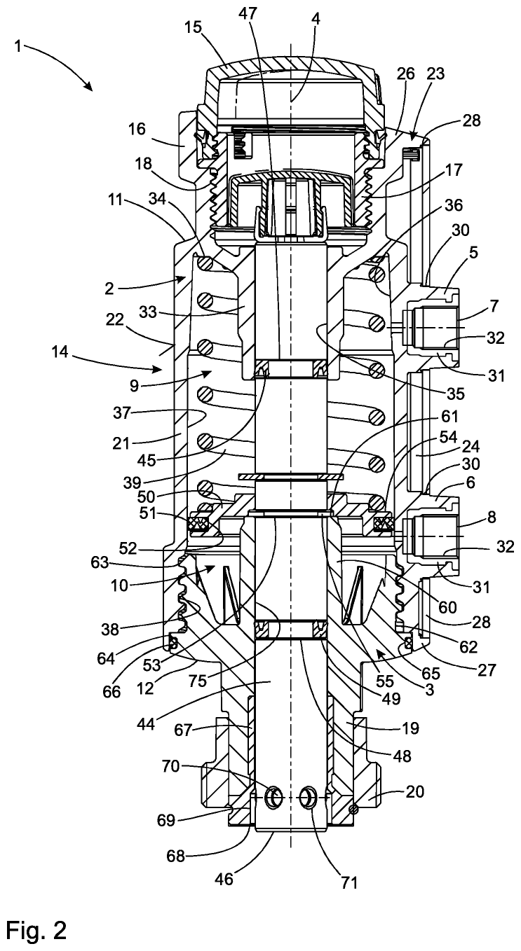

A pneumatic actuator 1 shown in different representations in FIGS. 1 and 2 is intended to provide a linear actuating movement for a valve, in particular a process valve, which is not shown, whereby this valve can be designed, for example, as a slide valve which is used in a process plant to influence a fluid flow in a fluid-carrying pipe.

The pneumatic actuator 1 is designed as a double-acting pneumatic cylinder. Thus, the pneumatic actuator 1 can be actively brought into two different functional positions by providing a pressurized fluid, whereby a spring device, which is described in more detail below, defines a preferred position for the pneumatic actuator 1 when no compressed air is applied to the pneumatic actuator 1.

As an example, it is provided that the pneumatic actuator 1 comprises a first outer body 2 and a second outer body 3, which are lined up along a movement axis 4 and are sealingly connected to one another and which form a cylinder housing 14. On the first outer body 2, a first fluid connection 5 and a second fluid connection 6 are formed, each of which is intended for the connection with a fluid line, for example a compressed air hose, which is not shown in detail.

The first fluid connection 5 is penetrated by a first fluid channel 7, which also extends through the first outer body 2 and enables a fluid-communicating connection between the first fluid connection 5 and a first working chamber 9 shown in FIG. 2. The second fluid connection 6 is penetrated by a second fluid channel 8, which also penetrates the first outer body 2 and is designed for a fluidically communicating connection with a second working space 10 shown in FIG. 2.

On an end face 11 of the first outer body 2, a cover 15 is arranged in a receptacle 16 belonging to the first outer body 2. As an example, it is provided that the cover 15 is screwed onto a screw sleeve 17, which in turn is screwed into a tapped hole 18 of the receptacle sleeve 16. As an example, it is intended that the cover 15 is made of a transparent plastic, for example PMMA (polymethyl methacrylate), so that an optical check of a functional position of the pneumatic actuator 1 can be carried out from outside by a user (not shown).

An adapter sleeve 19 is integrally formed on one end face 12 of the second outer body 3, which is designed for fixing the pneumatic actuator 1 to a valve, in particular a process valve, that is not shown. As an example, the adapter sleeve 19 is surrounded, at least in sections, by a fixing nut 20 mounted on the adapter sleeve 19 so that it can rotate about the axis of movement 4, which is intended for coupling the pneumatic actuator 1 with a housing of the valve, in particular a process valve, that is not shown.

It can be seen from the illustration in FIG. 2 that the first outer body 2 is essentially cup-shaped, for example having a first outer wall which is rotationally symmetrical to the axis of movement 4. The two fluid connections 5, 6 are formed on an outer surface 22 of the first outer wall 21. Furthermore, on the outer surface 22 of the first outer body 2, a circumferential frame 23 is formed, which surrounds the fluid connections 5, 6 and which comprises wall sections 24 and 25 or 26 and 27, respectively, which are aligned parallel to one another and which are respectively connected to one another at their ends. The wall sections 24 to 27 are each provided with a step-like recess 28 on an end face facing away from the first outer body 2, into which a plate-shaped cover 29 can be inserted. The plate-shaped cover 29 comprises two circular recesses 30, which are penetrated by the fluid connections 5, 6. Preferably, it is intended that the plate-shaped cover 29 is connected to the wall sections 24 to 27 in a material-locking manner (positive substance jointing), in particular by ultrasonic welding.

As an example, it is provided that each of the fluid connections 5, 6, which are each designed as sleeve-shaped sockets, is assigned a threaded insert 31, which is introduced into the respective fluid connection 5, 6 in a material-locking manner and has an internal thread 32. The threaded inserts 31 allow the screwing of fluid hoses which are not shown to allow compressed air to be applied to the two working chambers 9, 10.

A first piston rod guide 33 is arranged coaxially to the first outer wall 21, which is of circular-cylindrical design and which, starting from a circular-cylindrical base section 34 of the first outer body 2, extends approximately over 30 percent of a length extension of the first outer body 2 along the axis of movement 4. A circular cylindrical inner surface 35 of the first piston rod guide 33 serves as a sealing surface for a sealing 45 of the piston rod 44, which is mounted for linear movement along the movement axis 4 and described in more detail below.

The first outer wall 21 of the first outer body 2 has a first inner surface section 36, which extends along the axis of movement 4 and to which a second inner surface section 37 is connected, which merges into a threaded section 38 at an axial end region of the first outer body 2. For example, the first inner surface portion 36 is provided with a geometry extended in the direction of the second inner surface portion 37. The second inner surface portion 37 is circular cylindrical and is intended for sealing engagement of a sealing ring 51 received in a circumferential groove 52 of a working piston 50.

For example, it is intended that the working piston 50 is designed circular and rotationally symmetrical to the movement axis 4 and that it be penetrated by the piston rod 44, at which it is force-locked (friction-locked). In order to ensure an advantageous force transmission between the working piston 50 and the piston rod 44, the piston rod 44 in the region of the working piston 50 is provided with a circumferential groove 53 in which a circlip 55 is accommodated, which prevents axial movement of the working piston 50 along the axis of movement 4 relative to the piston rod 44 in a axial direction.

The piston rod 44 and the working piston 50 together define the first working space 9 with the first outer body 2 and the second working space 10 with the first outer body 2 and the second outer body 3. As an example it is provided that in the first working space 9 a spring is arranged which is constructed in particular as a helical spring 40 and which is supported on the annular base section 34 and on an annular end face 54 of the working piston 50. The spring 40 has an internal preload in the functional position as shown in FIG. 2 in order to press the working piston 50 with the circlip 55 against an axial end face 61 of the second piston rod guide 60 and to fix a preferred position for the working piston 50.

The second piston rod guide 60 is arranged coaxially with the second outer body 3, which outer body 3 is designed in the form of a beaker and which is provided with a thread 63 in a region of an outer surface 62, which thread 63 is designed for positive engagement in the thread section 38 of the first outer body 2. Furthermore, the outer surface 62 of the second outer body 3 comprises a circular cylindrical section 64 with a sealing groove 65, in which a sealing ring 66, designed for example as an O-ring, is accommodated, which sealing ring 66 is designed for sealing the second outer body 3 against the first outer body 2.

The second outer body 3 is connected to the integrally formed adapter sleeve 19, which is penetrated by the piston rod 44 and which is equipped at the end with a guide sleeve 67, which is in particular made of a metallic material. The guide sleeve 67 has a decoupling section 69 in the area of an opening 68, which decoupling section 69 has a larger diameter than the piston rod 44 and thus allows radial deflection of locking balls 70, which are accommodated in transverse bores 71 formed in the piston rod 44 transversely to the axis of movement 4.

As an example, it is provided that the piston rod 44, starting from an end face 46, is provided with a cylindrical bore (not shown) which is aligned coaxially to the axis of movement 4 and which is provided for receiving a connecting piece of a moving rod of a valve, in particular a process valve, which is also not shown. It is also provided that, in the preferred position as shown in FIG. 2, the locking balls 70 enable the piston rod 44 to be mounted on the moving rod. Subsequently—for example by screwing the fixing nut 20 to the housing (not shown) of the valve, in particular a process valve (not shown)—the piston rod 44 is displaced (directed upwards in accordance with the illustration in FIG. 2) along the movement axis 4 into a starting position which is not shown in more detail. As a result, the locking balls 70 are pressed radially inwards by interaction with the inner surface of the guide sleeve 67 and thereby effect the positive locking of the piston rod 44 with the movement rod of the valve, in particular a process valve (not shown).

In order to make both the first working chamber 9 and the second working chamber 10 fluid-tight, the piston rod 44 comprises two sealing grooves 47, 48, in which the upper sealing 45 and a lower sealing 49 are accommodated. Each of the upper sealing 45 and the lower sealing 49 is designed for a sealing contact on a circular cylindrical inner surface 35, 75 of the first piston rod guide 33 or the second piston rod guide 60.

What is claimed is:

1. A pneumatic actuator for actuating a valve, having a working piston which is mounted movably in a cylinder housing along a movement axis and delimits a variable-size working space with the cylinder housing and is connected to a piston rod which extends along the movement axis, the cylinder housing having a one-piece cup-shaped first outer body with a sleeve-shaped first piston rod guide arranged centrally in the first outer body and a one-piece cup-shaped second outer body with a sleeve-shaped second piston rod guide arranged centrally in the second outer body, the first piston rod guide and the second piston rod guide being spaced apart along the axis of movement and arranged coaxially with one another and being designed for linearly movable guidance of the piston rod, the working space is bounded by the first outer body and by the second outer body, and the piston rod passing through the end of the cylinder housing, wherein the piston rod is provided with at least one sealing in order to form a sealing connection with the associated piston rod guide.

2. The pneumatic actuator according to claim 1, wherein the at least one sealing is received in a circumferential sealing groove of the piston rod.

3. The pneumatic actuator according to claim 1, wherein the first outer body with the first piston rod guide is designed as a plastic injection-moulded part and/or wherein the second outer body with the second piston rod guide is designed as a plastic injection-moulded part.

4. The pneumatic actuator according to claim 1, wherein a fluid connection for connecting a fluid line is formed on an outer surface of the first outer body, and wherein a fluid channel starting from the fluid connection passes through the first outer body.

5. The pneumatic actuator according to claim 4, wherein a frame-shaped projection is formed on the outer surface of the first outer body, surrounding the fluid connection, on which projection a plate-shaped cover is fixed, which is penetrated by the fluid connection.

6. The pneumatic actuator according to claim 1, wherein an adapter sleeve is formed on the second outer body which extends coaxially with the second piston rod guide and through which the piston rod passes and which is provided at the end with a guide sleeve made of a metallic material, and wherein the piston rod is provided with a locking device arranged at the end for coupling to an actuating rod of a valve.

7. The pneumatic actuator according to claim 1, wherein a receiving sleeve is formed on the first outer body which extends coaxially with the first piston rod guide, which receiving sleeve delimits a common recess with the first piston rod guide and which is designed for movably receiving a functional element arranged on the end side of the piston rod from the group: optical indicator, sensor transmitter, travel limiter.

8. The pneumatic actuator according to claim 1, wherein the first outer body is sealingly connected to the second outer body.

9. The pneumatic actuator according to claim 1, wherein an annular space is formed between an inner surface of the first outer body and an outer surface of the first piston rod guide, in which annular space a spring is accommodated, which spring is supported on an end face of the working piston facing the annular space and on an inner end face of the first outer body.

10. The pneumatic actuator according to claim 1, wherein the first piston rod guide and/or the second piston rod guide has a cylindrical inner surface which is formed as a guide surface and as a sealing surface for the piston rod.
